(19) United States
(12) Patent Application Publication
(10) Pub. No.: US 2006/0250375 A1
(43) Pub. Date: Nov. 9, 2006

(54) Display card with a touch panel controller

(75) Inventors: Fou-Ming Liou, Taipei (TW); Yu-Liang Liu, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/403,826

(22) Filed: Apr. 14, 2006

(30) Foreign Application Priority Data
May 3, 2005 (TW) 94114277

(51) Int. Cl. G09G 5/00

(52) U.S. Cl. 345/173

(57) ABSTRACT

The present invention provides a display card with a touch panel controller. The controller is integrated into a display card. The controller is coupled to the touch screen through the unused pins of the coupling interface in the display card.

### RELATED APPLICATIONS

The present application is based on, and claims priority from, Taiwan Application Serial Number 94114277, filed May 3, 2005, the disclosure of which is hereby incorporated by reference herein in its entirety.

### FIELD OF THE INVENTION

The present invention regards a display card, and more particularly, a display card with a touch panel controller.

### BACKGROUND OF THE INVENTION

The keyboard and mouse have been the popular input devices for computers. However, the trends of computer miniaturization and interface simplification have rendered the keyboard and mouse too large in volume and too complex to use in comparison to the recently developed touch panel.

The structure of a typical resistance-type touch panel basically includes a thin film with an ITO layer formed over a glass substrate also with an ITO layer. When touching the panel, the ITO layer under the thin film contacts the ITO layer over the glass. A sensor senses this contact to send out a signal. This signal is sent to a computer through a controller to transform this signal to a pair of coordinates by a driver. By such transformation, this computer may know the touching position on the panel.

FIG. 1 illustrates a typical touch panel structure. A display card 106 is installed in a computer 100. The audio-video data received from a TV, the Internet or the computer 100 is transformed by the display card 106, and is sent to a screen 102 for displaying. The screen 102 has a touch panel 108. The controller 104 is coupled to the computer 100 through an RS232 or a USB interface. Then, this data selected on the touch panel 108 of the screen 102 is transferred to the computer 100 through the controller 104.

However, in the typical structure, the controller 104 is located outside of the computer 100, and wires are used to connect the controller 104 to the computer 100 and the screen 102. As more and more peripheral devices are connected to the computer 100, the wiring becomes increasingly more complex, making maintenance difficult and uglifying the overall appearance.

### SUMMARY OF THE INVENTION

Therefore, it is the main purpose of the present invention to provide a display card with a touch panel controller.

Another purpose of the present invention is to provide a system to integrate a touch panel controller.

Accordingly, the present invention provides a display card with a touch panel controller. The controller is integrated into a display card. The controller is coupled to the touch screen through the unused pins of the coupling interface in the display card.

In another embodiment, the present invention provides a simplified wire structure. A controller is integrated into a display card. The controller is coupled to the touch screen through the unused pins of the coupling interface in the display card. In such a structure, only one wire is required among the display card, the touch screen and the computer.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a typical touch panel structure;

FIG. 2 illustrates a touch panel structure of the present invention;

FIG. 3 illustrates the relationship between a display card with a touch panel controller and a motherboard according to the first embodiment of the present invention; and

FIG. 4 illustrates the relationship between a display card with a touch panel controller and a motherboard according to the second embodiment of the present invention.

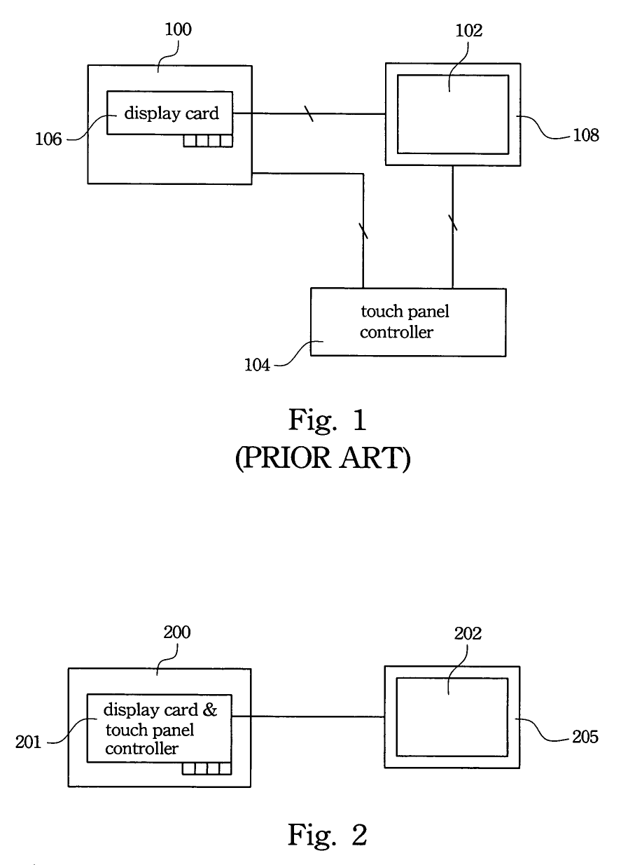

### DETAILED DESCRIPTION OF THE PREFERRED EMBODIMENT

FIG. 2 illustrates a computer system with touch panel structure of the present invention. According to the present invention, a typical touch panel controller is installed in the display card 201 of a system 200, such as a computer system. This touch panel controller is coupled to the screen 202 with touch panel 205 by using certain pins of a connection interface in the display card 201, such as a VGA card. Such a structure simplifies the wiring between the system 200 and the screen 202.

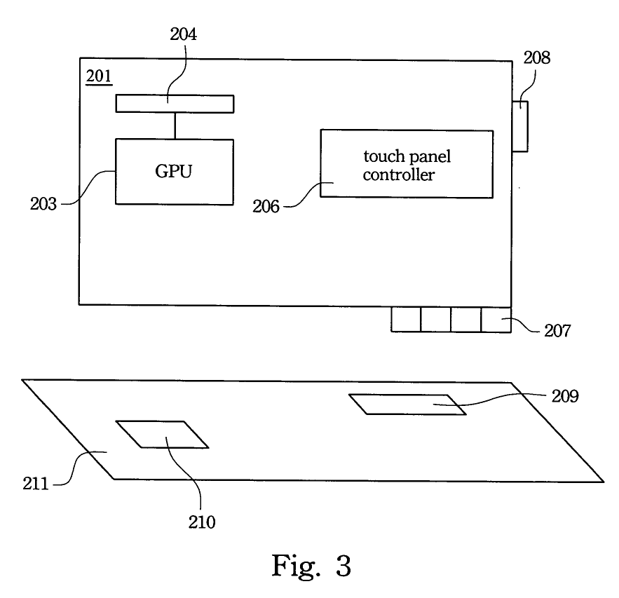

FIG. 3 illustrates the relationship between the display card 201 with a touch panel controller 206 and a motherboard 211 according to the first embodiment of the present invention. The display card includes a graphic processing unit (GPU) 203, a memory 204, a touch panel controller 206 and a commected interface 207.

Referring to FIGS. 2 and 3 together, the GPU 203 is used to process the graphic data for displaying on a display. The processed graphic data is stored in the memory 204. The memory 204 is an SDRAM, an SGRAM or a DDR SDRAM. When the touch panel 205 is touched, the touch panel controller 206 detects the voltage value or the electrical single generated by the touching to calculate the coordinates of the touch position. The connected interface 207 of the display card 201 is connected to the slot 209 of the motherboard 211 to provide a communication interface between the display card 201 and the motherboard 211 of the computer for exchanging data. The interface may be an AGP interface, PCI interface, PCI-E interface or other interface.

The coordinates calculated by the touch panel controller 206 are sent to the CPU 210 in the motherboard 211 through the connected interface 207 and slot 209. It is noticed that the touch panel controller 206 is elecrtic connected to the touch panel 205. In other embodiments, the functionality of the touch panel controller 206 is integrated into the GPU 203. In other words, in this embodiment, the GPU functions as a typical GPU and a touch panel controller.

A first connector 208 is used to connect the display card 201 to the screen 202 for transmitting data. In other words, the data processed by the GPU 203 is sent to the screen 202 through the first connector 208. The first connector 208 is a D-SUB connector, a DVI connector or an S-Video connector. There are some unused pins in the first connector 208 when the display card 201 and the screen 202 are connected together. Therefore, the touch panel controller 206 may be connected to the screen 202 through these unused pins.

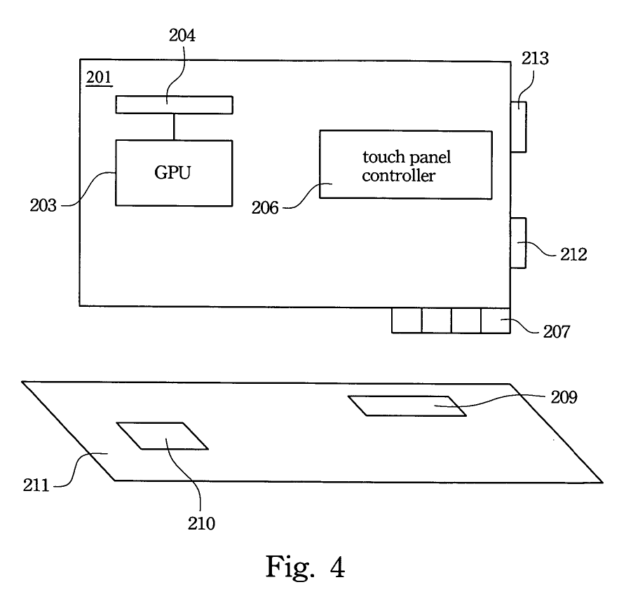

Hence, the signal which being produced when a user touches the touch panel 205 of the screen 202 is transmitted to the touch panel controller 206 through the first connector. Next, the data is transformed to the corresponding coordinate values by a driver in the system. Then, the index is displayed on the screen 202. According to a preferred embodiment of the present invention, the coordinate values are sent to the CPU 210 on the motherboard 211 through the connected interface 207 by the touch panel controller 206. The connection between the touch panel controller 206 and the screen 202 is through the certain pins in the first connector 208. Those certain pins are not be used in the traditional device. It is not necessary to use additional connectors and additional wires for transmitting data from the touch panel controller 206 to the screen 202. Such an invention helps to simplify the peripheral wiring. However, in other embodiments, the connection between the touch panel controller 206 and the screen 202 is through another connector. For example, in FIG. 4, the connection between the touch panel controller 206 and the screen 202 is through a third connector 212. The connection between the GPU 203 and the screen 202 is through a second connector 213.

Accordingly, the touch panel controller is integrated into the display card in the present invention. The connection between the touch panel controller and the screen is through certain pins of the first connector in the display card. Therefore, it is not necessary to use additional connectors and additional wires for transmitting data from the touch panel controller to the screen. Such an invention helps to simplify the peripheral wiring.

As it is understood by a person skilled in the art, the foregoing descriptions of the preferred embodiments of the present invention are illustrative of the present invention rather than limiting thereof. Various modifications and similar arrangements are included within the spirit and scope of the appended claims. The scope of the claims should be accorded to the broadest interpretation so as to encompass all such modifications and similar structures. While preferred embodiments of the invention have been illustrated and described, it will be appreciated that various changes can be made therein without departing from the spirit and scope of the invention.

What is claimed is:

1. A display card for a screen, wherein said screen has a touch part and a display part, comprising:
at least a first pin;
at least a second pin;
a graphic processing unit, wherein said graphic processing unit is coupled to said display part through said first pins; and
a touch panel controller, wherein said touch panel controller is coupled to said touch part through said second pins.

2. The display card of claim 1, wherein said first pins and said second pins are enclosed in a first connector.

3. The display card of claim 2, wherein said first connector is a DSUB connector, a DVI connector or an S-Video connector.

4. The display card of claim 1, wherein said first pins and said second pins are enclosed in a second connector and a third connector respectively.

5. The display card of claim 4, wherein both said second connector and said third connector are a DSUB connector.

6. The display card of claim 1, further comprising an interface for coupling with a motherboard, wherein said graphic processing unit and said touch panel controller are coupled with said motherboard through said interface.

7. The display card of claim 6, wherein said interface is an AGP interface.

8. The display card of claim 6, wherein said interface is a PCI interface.

9. A computer system, comprising:
a screen with a touch part and a display part;
a display card coupling with a motherboard, wherein said display card comprises
at least a first pin;
at least a second pin;
a graphic processing unit, wherein said graphic processing unit is coupled to said display part through said first pins; and
a touch panel controller, wherein said touch panel controller is coupled to said touch part through said second pins.

10. The computer system of claim 9, wherein said first pins and said second pins are enclosed in a first connector.

11. The computer system of claim 10, wherein said first connector is a DSUB connector, a DVI connector or an S-Video connector.

12. The computer system of claim 9, wherein said first pins and said second pins are enclosed in a second connector and a third connector respectively.

13. The computer system of claim 12, wherein both said second connector and said third connector are a DSUB connector.

14. The computer system of claim 9, said display card further comprising an interface for coupling with said motherboard.

15. The computer system of claim 14, wherein said interface is an AGP interface.

16. The computer system of claim 14, wherein said interface is a PCI interface.
